(19) United States
(12) Patent Application Publication
(10) Pub. No.: US 2021/0325923 A1
(43) Pub. Date: Oct. 21, 2021

(54) REFERENCE VOLTAGE GENERATION SYSTEM AND METHOD

(71) Applicants: HKC CORPORATION LIMITED, Shenzhen (CN); CHONGQING HKC OPTOELECTRONICS TECHNOLOGY CO., LTD., Chongqing (CN)

(72) Inventor: XIAOYU HUANG, Chongqing (CN)

(21) Appl. No.: 16/314,861

(22) PCT Filed: Oct. 31, 2018
(86) PCT No.: PCT/CN2018/112849

§ 371 Date: Jan. 3, 2019

(30) Foreign Application Priority Data
Jul. 24, 2018 (CN) 201810815500.9

(51) Int. Cl. G05F 3/24

(52) U.S. Cl. CPC G05F 3/24

(57) ABSTRACT

The present application discloses a reference voltage generation system and method. The reference voltage generation system includes: a reference voltage generator; and a voltage division circuit coupled to the reference voltage generator. The reference voltage generator is coupled to a reference voltage through the voltage division circuit.

The present application claims priority to the Chinese Patent Application No. CN201810815500.9, filed to the Chinese Patent Office on Jul. 24, 2018, and entitled “REFERENCE VOLTAGE GENERATION SYSTEM AND METHOD”, which is incorporated herein by reference in its entirety.

### TECHNICAL FIELD

This disclosure relates to a reference voltage generation system and a generation method thereof.

### BACKGROUND

The statements herein merely provide background information related to the present application and do not necessarily constitute the prior art.

With the development and advancement of technologies, a liquid crystal display has become a mainstream product of display due to its thin body, power-saving, low radiation and the like, and thus has become an important display platform for IT and video products.

From the perspective of the driving principle of the liquid crystal display, a system mainboard passes a red/green/blue compression signal and a control signal as well as a power supply through a wire, and finally connects to a display region of a display panel, so that the display panel obtains the required power and signal.

The display of the liquid crystal display is driven by voltage, and an array substrate and a color film substrate both ensure the smooth progress of the display process through a reference voltage, and the reference voltages of the array substrate and the color film substrate are often common, although in most of the time, the voltage commonality is not a problem, but the study found that the common use of the reference voltages may cause problems such as image sticking.

### SUMMARY

The present application provides a reference voltage generation system and method for generating two servo reference voltages to improve panel quality.

To achieve the foregoing objective, the present application provides a reference voltage generation system, including:

a reference voltage generator, configured to generate a reference voltage;

a voltage division circuit, coupled to the reference voltage generator and configured to divide the reference voltage;

a first substrate, including a first reference voltage; and

a second substrate, including a second reference voltage;

the reference voltage generator is coupled to the first reference voltage and/or the second reference voltage through the voltage division circuit.

Optionally, the second reference voltage is coupled to the reference voltage generator.

The reference voltage generation system further includes:

a first switch transistor, a source electrode of which is coupled to the reference voltage generator, a drain electrode is coupled to the second reference voltage of the second substrate, and a gate electrode is coupled to a control signal; and

a second switch transistor, a source electrode of which is coupled to an output end of the voltage division circuit, a drain electrode is coupled to the second reference voltage of the second substrate, and a gate electrode is coupled to the gate electrode of the first switch transistor.

Optionally, the voltage division circuit includes:

a second voltage divider, one end of which is grounded, and

a first voltage divider, one end of which is coupled to the reference voltage generator, and the other end is grounded through the second voltage divider;

the second reference voltage is coupled between the first voltage divider and the second voltage divider.

Optionally, the reference voltage generation system further includes:

an operational amplifier, one end of which is connected between the first voltage divider and the second voltage divider, and the other end is connected to the second reference voltage.

Optionally, a resistance value of the first voltage divider or the second voltage divider is adjustable.

Optionally, the reference voltage generation system further includes:

a central control panel including a timing controller, the timing controller being configured to output the control signal; and a circuit board, on which the reference voltage generator and the voltage division circuit are disposed.

The present application further discloses a reference voltage generation method, including the following steps:

generating a reference voltage by a reference voltage generator of a circuit board; and

conveying the reference voltage to a second reference voltage of the second substrate through a voltage division circuit, and meanwhile, conveying the reference voltage to a first reference voltage of the first substrate.

Optionally, the step of conveying the reference voltage to a second reference voltage of the second substrate through a voltage division circuit, and meanwhile, conveying the reference voltage to a first reference voltage of the first substrate includes:

dividing the reference voltage by the voltage division circuit to obtain a divided voltage; and

conveying the divided voltage to the second reference voltage after being processed by an operational amplifier.

Optionally, the step of conveying the reference voltage to a second reference voltage of the second substrate through a voltage division circuit, and meanwhile, conveying the reference voltage to a first reference voltage of the first substrate further includes:

coupling an output end of the operational amplifier to the second reference voltage through a first switch transistor when a control signal is in high level.

Optionally, the step of conveying the reference voltage to a second reference voltage of the second substrate through a voltage division circuit, and meanwhile, conveying the reference voltage to a first reference voltage of the first substrate further includes:

coupling the reference voltage generator to the second reference voltage through a second switch transistor when the control signal is in high level.

According to the reference voltage generation system of the present application, the reference voltage generator can be further improved according to the panel needs, and the reference voltage generator of the exemplary architecture can be used. In addition, the generation circuit further includes a voltage division circuit, which is configured to divide the reference voltage and then conveys the divided voltage to the first reference voltage or the second reference voltage, so that the first reference voltage and the second reference voltage are independent of each other, thereby preventing the first reference voltage and the second reference voltage from interfering with each other to cause image sticking, and improving the quality and yield of the panel.

### BRIEF DESCRIPTION OF DRAWINGS

The drawings are included to provide optional understanding of embodiments of the present application, which constitute a part of the specification and illustrate the embodiments of the present application, and describe the principles of the present application together with the text description. Apparently, the accompanying drawings in the following description show merely some embodiments of the present application, and a person of ordinary skill in the art may still derive other accompanying drawings from these accompanying drawings without creative efforts. In the accompanying drawings:

FIG. 1 is a schematic diagram of a reference voltage generation system according to one of the embodiments of the present application;

FIG. 2 is a specific circuit diagram of a reference voltage generation system according to one of the embodiments of the present application; and

FIG. 3 is an application flowchart of a reference voltage generation method according to one of the embodiments of the present application.

### DETAILED DESCRIPTION

The specific structure and function details disclosed herein are merely representative, and are intended to describe exemplary embodiments of the present application. However, the present application can be specifically embodied in many alternative forms, and should not be interpreted to be limited to the embodiments described herein.

In the description of the present application, it should be understood that, orientation or position relationships indicated by the terms “center”, “transversal”, “upper”, “lower”, “left”, “right”, “vertical”, “horizontal”, “top”, “bottom”, “inner”, “outer”, etc. are based on the orientation or position relationships as shown in the drawings, for ease of the description of the present application and simplifying the description only, rather than indicating or implying that the indicated device or element must have a particular orientation or be constructed and operated in a particular orientation. Therefore, these terms should not be understood as a limitation to the present application. In addition, the terms such as “first” and “second” are merely for a descriptive purpose, and cannot be understood as indicating or implying a relative importance, or implicitly indicating the number of the indicated technical features. Hence, the features defined by “first” and “second” can explicitly or implicitly include one or more features. In the description of the present application, “a plurality of” means two or more, unless otherwise stated. In addition, the term “include” and any variations thereof are intended to cover a non-exclusive inclusion.

In the description of the present application, it should be understood that, unless otherwise specified and defined, the terms “install”, “connected with”, “connected to” should be comprehended in a broad sense. For example, these terms may be comprehended as being fixedly connected, detachably connected or integrally connected; mechanically connected or electrically connected; or directly connected or indirectly connected through an intermediate medium, or in an internal communication between two elements. The specific meanings about the foregoing terms in the present application may be understood by a person of ordinary skill in the art according to specific circumstances.

The terms used herein are merely for the purpose of describing the specific embodiments, and are not intended to limit the exemplary embodiments. As used herein, the singular forms “a”, “an” are intended to include the plural forms as well, unless otherwise indicated in the context clearly. It will be further understood that the terms “comprise” and/or “include” used herein specify the presence of the stated features, integers, steps, operations, elements and/or components, but do not preclude the presence or addition of one or more other features, integers, steps, operations, elements, components and/or combinations thereof.

In the drawings, units of similar structures are represented by the same reference numerals.

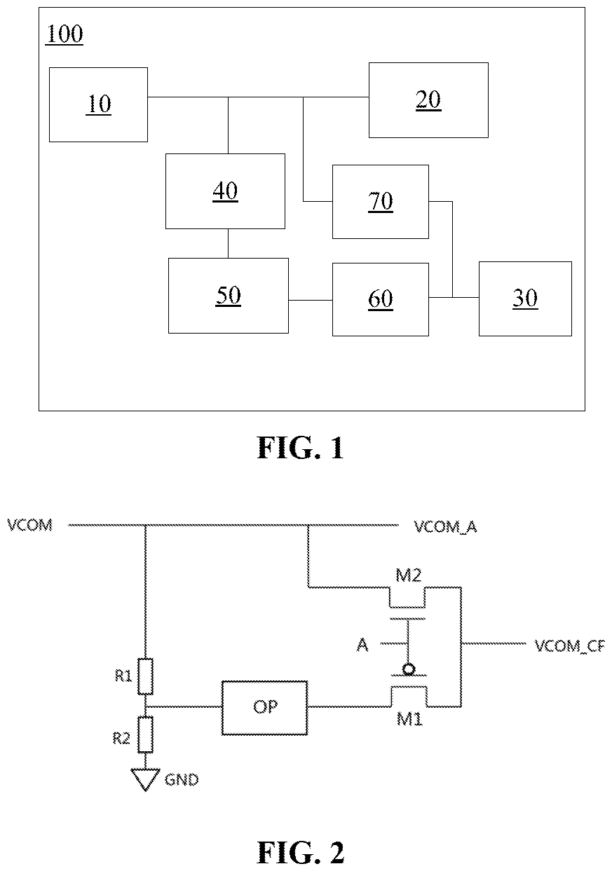

FIG. 1 is a schematic diagram of a reference voltage generation system according to the present application; and FIG. 2 is a specific circuit diagram of a reference voltage generation system according to the present application. Referring to FIGS. 1 and 2.

The present application provides a reference voltage generation system 100, including:

a reference voltage generator 10, configured to generate a reference voltage (corresponding to the reference numeral VCOM in FIG. 2); and

a voltage division circuit 40, coupled to the reference voltage generator 10 and configured to divide the reference voltage.

The reference voltage generator 10 is coupled to a first reference voltage VCOM_A and/or a second reference voltage VCOM_CF through the voltage division circuit 40.

According to the reference voltage generation system of the present application, the reference voltage generator can be further improved according to the panel needs, and the reference voltage generator of the exemplary architecture can be used. In addition, the generation circuit further includes a voltage division circuit, which is configured to divide the reference voltage and then conveys the divided voltage to the first reference voltage or the second reference voltage, so that the first reference voltage and the second reference voltage are independent of each other, thereby preventing the first reference voltage and the second reference voltage from interfering with each other to cause image sticking, and improving the quality and yield of the panel.

In an embodiment, the second reference voltage is coupled to the reference voltage generator 10.

The reference voltage generation system 100 further includes:

a first switch transistor 60 (corresponding to the reference numeral M1 in FIG. 2), a source electrode of which is coupled to the reference voltage generator 10, a drain electrode is coupled to the second reference voltage, and a gate electrode is coupled to a control signal A; and

a second switch transistor 70 (corresponding to the reference numeral M2 in FIG. 2), a source electrode of which is coupled to an output end of the voltage division circuit 40, a drain electrode is coupled to the second reference voltage, and a gate electrode is coupled to the gate electrode of the first switch transistor 60. In this embodiment, the first switch transistor is optionally a PMOS transistor, and the second switch transistor is optionally an NMOS transistor; the first reference voltage is equal to the reference voltage; the second reference voltage is coupled to the reference voltage generator through the voltage division circuit, the first switch transistor, or the second switch transistor; when the second reference voltage is coupled to the reference voltage generator through the second switch transistor, the second reference voltage is equal to the reference voltage; and when the second reference voltage is coupled to the reference voltage generator through the voltage division circuit and the first switch transistor, the second reference voltage is equal to the divided voltage. In this way, the drive architecture decides whether to respectively set the first reference voltage and the second reference voltage according to whether to improve the image quality problems such as image sticking.

In an embodiment, the voltage division circuit 40 includes:

a second voltage divider R2, one end of which is grounded; and

a first voltage divider R1, one end of which is coupled to the reference voltage generator 10, and the other end is grounded through the second voltage divider R2.

The second reference voltage is coupled between the first voltage divider R1 and the second voltage divider R2. In this embodiment, the first voltage divider and the second voltage divider may be resistors or others. Taking a voltage division resistor as an example, a voltage value B of the divided voltage is related to the ratio of the first voltage divider R1 to the second voltage divider R2, specifically, B=VCOM*R2/(R1+R2). In this way, the voltage values of the first voltage divider R1 to the second voltage divider R2 are kept as follows, so that the second reference voltage is adjusted by adjusting the sizes of the first voltage divider and the second voltage divider according to actual conditions to ensure adaptation to a specific display panel.

In an embodiment, the reference voltage generation system 100 further includes:

an operational amplifier 50 (corresponding to the reference numeral OP in FIG. 2), one end of which is connected between the first voltage divider R1 and the second voltage divider R2, and the other end is connected to the second reference voltage. In this embodiment, an operational amplifier is further provided between the second reference voltage and the voltage division circuit. The operational amplifier is a power operational amplifier. Due to the possible wear and tear in the voltage division circuit, it is needed to provide a power operational amplifier to increase a driving circuit of the second reference voltage, to avoid the back-end panel load affecting the voltage value of the second reference voltage, resulting in driving and display problems.

In an embodiment, the first voltage divider R1 includes a first resistor, and the second voltage divider R2 includes a second resistor, where the first voltage divider R1 and the second voltage divider R2 may be a resistor, separately, or may be a set of resistors connected in series-parallel. Moreover, the resistor or the set of resistors may be a fixed resistance value after pre-testing, or may be a variable resistor to suit a wider variety of panels.

In an embodiment, a resistance value of the first voltage divider R1 or the second voltage divider R2 is adjustable. In this embodiment, the first voltage divider or the second voltage divider may be detachable and replaceable, or may be a variable resistor with a variable resistance value. In this way, for different panels, the first reference voltage can be changed by adjusting the voltage of the reference voltage generator, and a second reference voltage in proportional to the first reference voltage is obtained by changing the resistance value of the first voltage divider or the second voltage divider.

In an embodiment, the reference voltage generation system 100 further includes:

a central control panel (not shown) including a timing controller (not shown), the timing controller being configured to output the control signal, and a circuit board (not shown), on which the reference voltage generator and the voltage division circuit are disposed. In this embodiment, the timing controller is configured to output a control signal; and the control signal is configured to control turn-on of the first and second switch transistors; when the control signal A is in low level, the first switch transistor is turned on, and the second switch transistor is turned off, at this time, the first reference voltage is equal to the reference voltage, and the second reference voltage is equal to the divided voltage; when the control signal A is in high level, the first switch transistor is turned off, and the second switch transistor is turned on, at this time, the first reference voltage is equal to the reference voltage, and the second reference voltage is equal to the reference voltage. In this way, the drive architecture decides whether to respectively set the first reference voltage and the second reference voltage according to whether to improve the image quality problems such as image sticking, thereby expanding the scope of application.

The circuit board may include a Printed Circuit Board (PCB), or other similar devices.

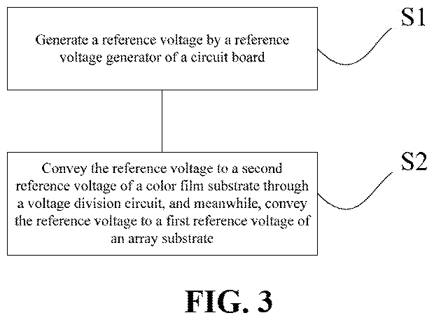

FIG. 3 is an application flowchart of a reference voltage generation method according to the present application. Referring to FIGS. 1, 2, and 3, the present application further discloses a reference voltage generation method, including the following steps:

S1: Generate a reference voltage by a reference voltage generator of a circuit board.

S2: Convey the reference voltage to a second reference voltage through a voltage division circuit, and meanwhile, convey the reference voltage to a first reference voltage.

The reference voltage generation method according to the present application is an application method based on the reference voltage generation system, where the reference voltage generator can be further improved according to the panel needs, and the reference voltage generator of the exemplary architecture can be used. In addition, the generation circuit further includes a voltage division circuit, which is configured to divide the reference voltage and then conveys the divided voltage to the first reference voltage or the second reference voltage, so that the first reference voltage and the second reference voltage are independent of each other, thereby preventing the first reference voltage and the second reference voltage from interfering with each other to cause image sticking, and improving the quality and yield of the panel.

In an embodiment, the step of conveying the reference voltage to a second reference voltage through a voltage division circuit, and meanwhile, conveying the reference voltage to a first reference voltage includes:

Divide the reference voltage by the voltage division circuit to obtain a divided voltage.

Convey the divided voltage to the second reference voltage after being processed by an operational amplifier. In this embodiment, the divided voltage is conveyed to the second reference voltage after being subjected to driving power amplification in the operation amplifier, to avoid the back-end panel load affecting the voltage value of the voltage divided by a resistor, resulting in driving and display problems.

In an embodiment, the step of conveying the reference voltage to a second reference voltage through a voltage division circuit, and meanwhile, conveying the reference voltage to a first reference voltage further includes:

When the control signal is in high level, an output end of the operation amplifier is coupled to the second reference voltage through the first switch transistor. In this embodiment, the timing controller is configured to output a control signal, and the control signal is configured to control turn-on of the first and second switch transistors: when the control signal A is in high level, the first switch transistor is turned off, and the second switch transistor is turned on, at this time, the first reference voltage is equal to the reference voltage, and the second reference voltage is equal to the reference voltage. In this way, the drive architecture decides whether to respectively set the first reference voltage and the second reference voltage according to whether to improve the image quality problems such as image sticking, thereby expanding the scope of application.

In an embodiment, the step of conveying the reference voltage to a second reference voltage through a voltage division circuit, and meanwhile, conveying the reference voltage to a first reference voltage further includes:

When the control signal is in low level, the reference voltage generator is coupled to the second reference voltage through the second switch transistor. In this embodiment, the timing controller is configured to output a control signal, and the control signal is configured to control turn-on of the first and second switch transistors; when the control signal A is in low level, the first switch transistor is turned on, and the second switch transistor is turned off, at this time, the first reference voltage is equal to the reference voltage, and the second reference voltage is equal to the divided voltage.

The panel of the present application may be a Twisted Nematic (TN) panel, an In-Plane Switching (IPS) panel, and a Multi-domain Vertical Alignment (VA) panel, and of course, can also be other types of panels, if appropriate.

The contents above are further detailed descriptions of the present application in conjunction with specific embodiments, and the specific implementation of the present application is not limited to these descriptions. It will be apparent to a person of ordinary skill in the art that various simple deductions or substitutions may be made without departing from the spirit of the present application, and should be considered to fall into the scope of protection of the present application.

1. A reference voltage generation system, comprising:
a reference voltage generator, configured to generate a reference voltage; and
a voltage division circuit, coupled to the reference voltage generator and configured to divide the reference voltage;
the reference voltage generator is coupled to a first reference voltage and/or a second reference voltage through the voltage division circuit;
the reference voltage is coupled to the reference voltage generator;
the reference voltage generation system further comprises:
a first switch transistor, a source electrode of which is coupled to the reference voltage generator, a drain electrode is coupled to the second reference voltage, and a gate electrode is coupled to a control signal; and
a second switch transistor, a source electrode of which is coupled to an output end of the voltage division circuit, a drain electrode is coupled to the second reference voltage, and a gate electrode is coupled to the gate electrode of the first switch transistor;
the voltage division circuit comprises:
a second voltage divider, one end of which is grounded; and
a first voltage divider, one end of which is coupled to the reference voltage generator, and the other end is grounded through the second voltage divider;
the second reference voltage is coupled between the first voltage divider and the second voltage divider;
the reference voltage generation system further comprises:
an operational amplifier, one end of which is connected between the first voltage divider and the second voltage divider, and the other end is connected to the second reference voltage;
a resistance value of the first voltage divider or the second voltage divider is adjustable.

2. A reference voltage generation system, comprising:
a reference voltage generator, configured to generate a reference voltage; and
a voltage division circuit, coupled to the reference voltage generator and configured to divide the reference voltage;
the reference voltage generator is coupled to a first reference voltage and or a second reference voltage through the voltage division circuit.

3. The reference voltage generation system according to claim 2, wherein the first reference voltage is coupled to the reference voltage generator;
the reference voltage generation system further comprises:
a first switch transistor, a source electrode of which is coupled to the reference voltage generator, a drain electrode is coupled to the second reference voltage, and a gate electrode is coupled to a control signal; and
a second switch transistor, a source electrode of which is coupled to an output end of the voltage division circuit, a drain electrode is coupled to the second reference voltage, and a gate electrode is coupled to the gate electrode of the first switch transistor.

4. The reference voltage generation system according to claim 3, wherein the first switch transistor is a PMOS transistor.

5. The reference voltage generation system according to claim 3, wherein the second switch transistor is an NMOS transistor.

6. The reference voltage generation system according to claim 2, wherein the voltage division circuit comprises:
a second voltage divider, one end of which is grounded; and
a first voltage divider, one end of which is coupled to the reference voltage generator, and the other end is grounded through the second voltage divider;
the second reference voltage is coupled between the first voltage divider and the second voltage divider.

7. The reference voltage generation system according to claim 6, wherein the first voltage divider comprises a first resistor; and the first resistor and the second voltage divider are connected in series.

8. The reference voltage generation system according to claim 6, wherein the second voltage divider comprises a second resistor, and the second resistor and the first voltage divider are connected in series.

9. The reference voltage generation system according to claim 6, wherein the first voltage divider comprises a first resistor; the second voltage divider comprises a second resistor; and the first resistor and the second resistor are connected in series.

10. The reference voltage generation system according to claim 9, wherein the first resistor and the second resistor are fixed resistors.

11. The reference voltage generation system according to claim 6, wherein the reference voltage generation system further comprises: an operational amplifier, one end of which is connected between the first voltage divider and the second voltage divider, and the other end is connected to the second reference voltage.

12. The reference voltage generation system according to claim 6, wherein a resistance value of the first voltage divider or the second voltage divider is adjustable.

13. The reference voltage generation system according to claim 3, wherein the reference voltage generation system further comprises:
a central control panel comprising a timing controller, the timing controller being configured to output the control signal; and
a circuit board, on which the reference voltage generator and the voltage division circuit are disposed.

14. The reference voltage generation system according to claim 13, wherein the circuit board is a printed circuit board.

15. A reference voltage generation method, comprising the following steps:
generating a reference voltage by a reference voltage generator of a circuit board; and
conveying the reference voltage to a second reference voltage through a voltage division circuit, and meanwhile, conveying the reference voltage to a first reference voltage.

16. The reference voltage generation method according to claim 15, wherein the step of conveying the reference voltage to a second reference voltage through a voltage division circuit, and meanwhile, conveying the reference voltage to a first reference voltage comprises:
dividing the reference voltage by the voltage division circuit to obtain a divided voltage; and
conveying the divided voltage to the second reference voltage after being processed by an operational amplifier.

17. The reference voltage generation method according to claim 16, wherein the step of conveying the reference voltage to a second reference voltage through a voltage division circuit, and meanwhile, conveying the reference voltage to a first reference voltage further comprises:
coupling an output end of the operational amplifier to the second reference voltage through a first switch transistor when a control signal is in high level;
the step of conveying the reference voltage to a second reference voltage through a voltage division circuit, and meanwhile, conveying the reference voltage to a first reference voltage further comprises:
coupling the reference voltage generator to the second reference voltage through a second switch transistor when the control signal is in high level.
